(19) United States
(12) Patent Application Publication
(10) Pub. No.: US 2017/0076632 A1
(43) Pub. Date: Mar. 16, 2017

(54) SYSTEM AND GAMING METHOD FOR AIDING IN LEARNING MATH TABLES

(71) Applicant: Cynthia Crocker, Philadelphia, PA (US)

(72) Inventor: Cynthia Crocker, Philadelphia, PA (US)

(21) Appl. No.: 15/263,211

(22) Filed: Sep. 12, 2016

Related U.S. Application Data
(60) Provisional application No. 62/217,853, filed on Sep. 12, 2015.

(51) Int. Cl. G09B 19/02; A63F 13/80; A63F 3/04; A63F 9/18

(52) U.S. Cl. CPC G09B 19/025; A63F 9/18; A63F 13/80; A63F 3/0415

(57) ABSTRACT

A system and gaming method are disclosed. In various embodiments, a method for implementing multiplication table as an aid in learning math tables is disclosed.

This application claims the benefit to U.S. Provisional Application No. 62/217,853, filed on Sep. 12, 2015, which application is incorporated herein by reference as if set forth in its entirety.

### FIELD OF THE INVENTION

The present invention relates generally to the field of networked gaming, and more particularly to system and gaming method for aiding in learning math tables.

### BACKGROUND OF THE INVENTION

Traditional math table learning arrangements are based on repetition as a tool for learning the material. For example, early learners are asked to repetitively recite their math tables. Often, these math tables that are presented to the learner simply expose the information in the form of a traditional table. Such method becomes a cliche and thus becomes ineffective as a learning tool.

### SUMMARY OF THE INVENTION

Various embodiments provide a system and gaming method for aiding in learning math tables.

In one embodiment, a computer-implemented method is provided. The method comprises the steps of accessing a networking system multiplication table associated with a plurality of multiplicands to register as a competitor of said networking system multiplication table, the multiplication table associated with a plurality of multipliers and a plurality of products in a predetermined order; presenting said plurality of multiplicands to the registered competitor; selecting one of the plurality of multiplicands; associating a number to registered competitors sequentially; determining the starting point and length of a particular round; generating, by a processor, a multiplication time strip corresponding to the selected multiplicand; establishing a time-window for competitors to provide the correct answer; presenting a question associated with the selected multiplicand to the competitor with highest priority; and sending for display to the viewing user earned points based on the answer provided.

Another embodiment provides a system, which includes a non-transitory computer-readable storage medium comprising executable computer instructions configured to, when executed, perform the steps comprising accessing a networking system multiplication table associated with a plurality of multiplicands to register as a competitor of said networking system multiplication table, the multiplication table associated with a plurality of multipliers and a plurality of products in a predetermined order; presenting said plurality of multiplicands to the registered competitor; selecting one of the plurality of multiplicands; associating a number to registered competitors sequentially; determining the starting point and length of a particular round; generating, a multiplication time strip corresponding to the selected multiplicand; establishing a time-window for competitors to provide the correct answer; presenting a question associated with the selected multiplicand to the competitor with highest priority; and sending for display to the viewing user earned points based on the answer provided; and a processor configured to execute the computer instructions.

Yet another embodiment provides a non-transitory computer readable medium. The non-transitory computer readable medium has stored thereon instructions that, upon execution by a computing device, cause the computing device to perform certain functions. The functions include presenting a plurality of multiplicands to a registered competitor; selecting one of the plurality of multiplicands; associating a number to registered competitors sequentially; determining the starting point and length of a particular round; generating, by a processor, a multiplication time strip corresponding to the selected multiplicand; establishing a time-window for competitors to provide the correct answer; presenting a question associated with the selected multiplicand to the competitor with highest priority; and sending for display to the viewing user earned points based on the answer provided, wherein multiplication table associated with a plurality of multiplicands to register as a competitor of said networking system multiplication table, the multiplication table associated with a plurality of multipliers and a plurality of products in a predetermined order.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system benefiting from embodiments of the present invention;

FIG. 2 depicts a high-level block diagram of an implementation according to the system of FIG. 1;

FIG. 3 depicts an exemplary computing device suitable for use in the system depicted in FIG. 1;

FIG. 4 depicts one embodiment of a shape incorporating therein the factors associated with a Multiplicand.

FIG. 5 depicts one embodiment of a Multiplication Strip associated a Multiplicand; and

FIG. 6 depicts Flow Chart of a process for implementing the algorithm according to an embodiment of the invention.

To facilitate understanding, identical reference numerals have been used to designate elements having substantially the same or similar structure and/or substantially the same or similar function.

### DETAILED DESCRIPTION OF THE INVENTION

Various embodiments provide a system and gaming method for aiding in learning math tables.

The illustrative system and method embodiments described herein are not meant to be limiting. It may be readily understood that certain aspects of the disclosed system and method can be arranged and combined in a variety of different configurations, all of which are contemplated herein.

In one embodiment, an exemplary computing device is configured to allow one or more competitors to access the system to begin a session.

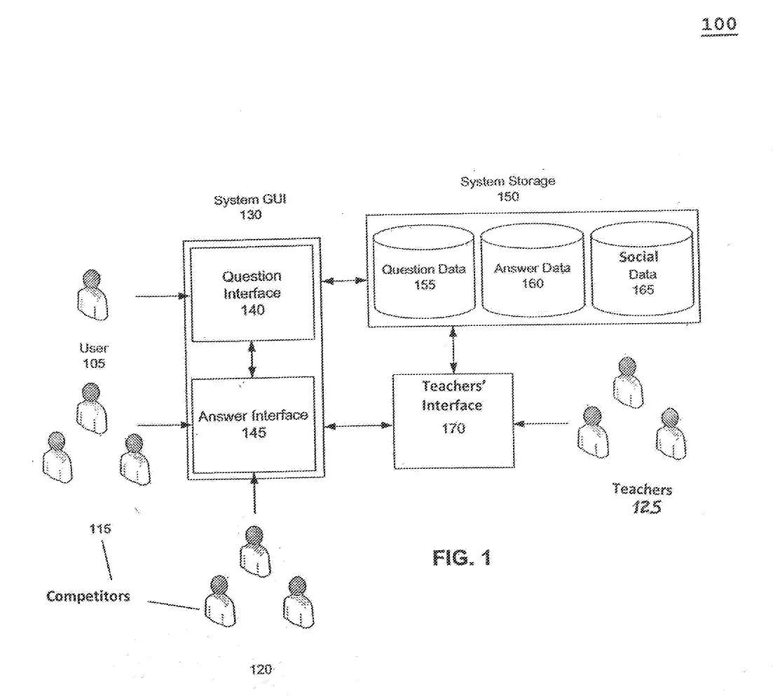

Referring now to the figures, FIG. 1 is a simplified block diagram of a system 100, according to an exemplary embodiment herein described. The multiplication table networking system 100 comprises a networking graphical user interface (GUI) 130, system storage 150, teachers' interface 170. GUI 130 is used for displaying a question and answer during a session. In one embodiment, the multiplication table GUI 130 is used for all math table networking system pages. In other embodiment, the multiplication table GUI 130 is customized for a particular question and answer session. For example, the session may be a beginner learning session, an intermediate learning session, an advanced learning session as opposed to a dry-run session or a competitive session. In other embodiments, the learning session mode allows for automatic operation or teacher-assisted operation. Teachers' interface 170 is used in the teacher assisted mode. In this mode, the teacher may implement any learning plan by configuring the system for such operation. The plan may be downloaded from the Internet or the system may suggest a plan or the teacher may design a plan.

The multiplication table GUI 130 comprises a question interface 140 and an answer interface 145. In one embodiment, question interface 140 and an answer interface 145 comprise the same interface.

Question data is stored in question data storage 155. Answer data is stored in answer data storage 160. Data associated with users 105, 115, 120 and 125 such as demographics, grade, gender, level of education, school attended, interaction data are stored in social data storage 165. This database is also used for authentication purposes. Content associated with users such as messages, queued messages (e.g., email), text and SMS (short message service) messages, comment messages, messages sent using any suitable messaging technique, an HTTP link, HTML files, images, videos, audio clips, documents, document edits, calendar entries, events and other computer related files. Content items may be anything a user may upload, edit or interact with.

As described above, the system comprises different modes of operation. The mode of operation determines the configuration of the question interface. For example, the question interface adapts to the mode of operation by allowing the user to determine whether or not questions are asked in random or sequentially or the user can choose a specific pattern for the questions to be asked. A user may add a tab or a button in the GUI, which may be used to display the question interface. In other embodiments, question interface 140 includes the functionality enabling a user to tag a specific mode of operation.

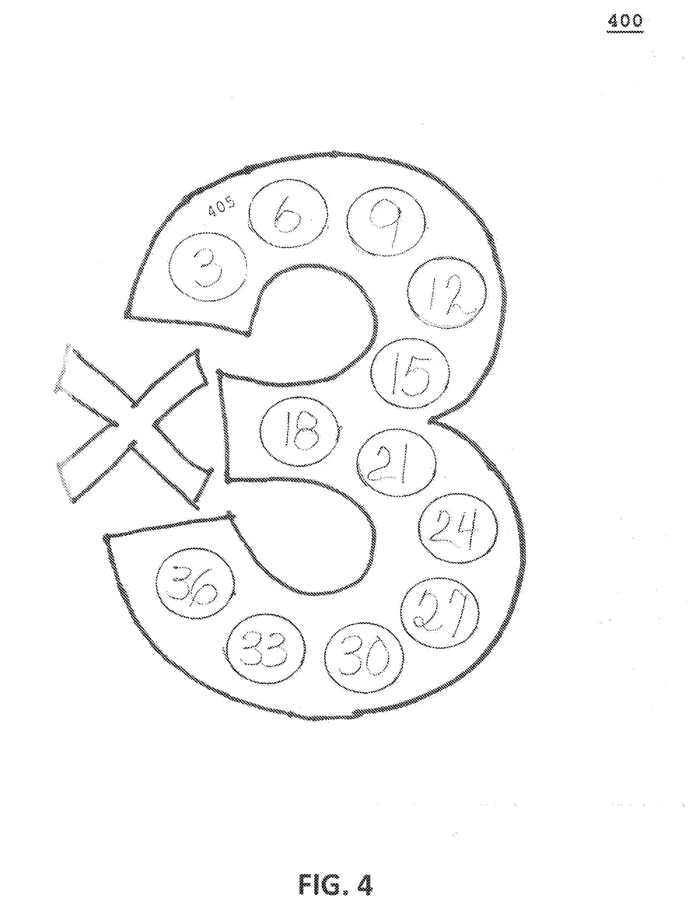

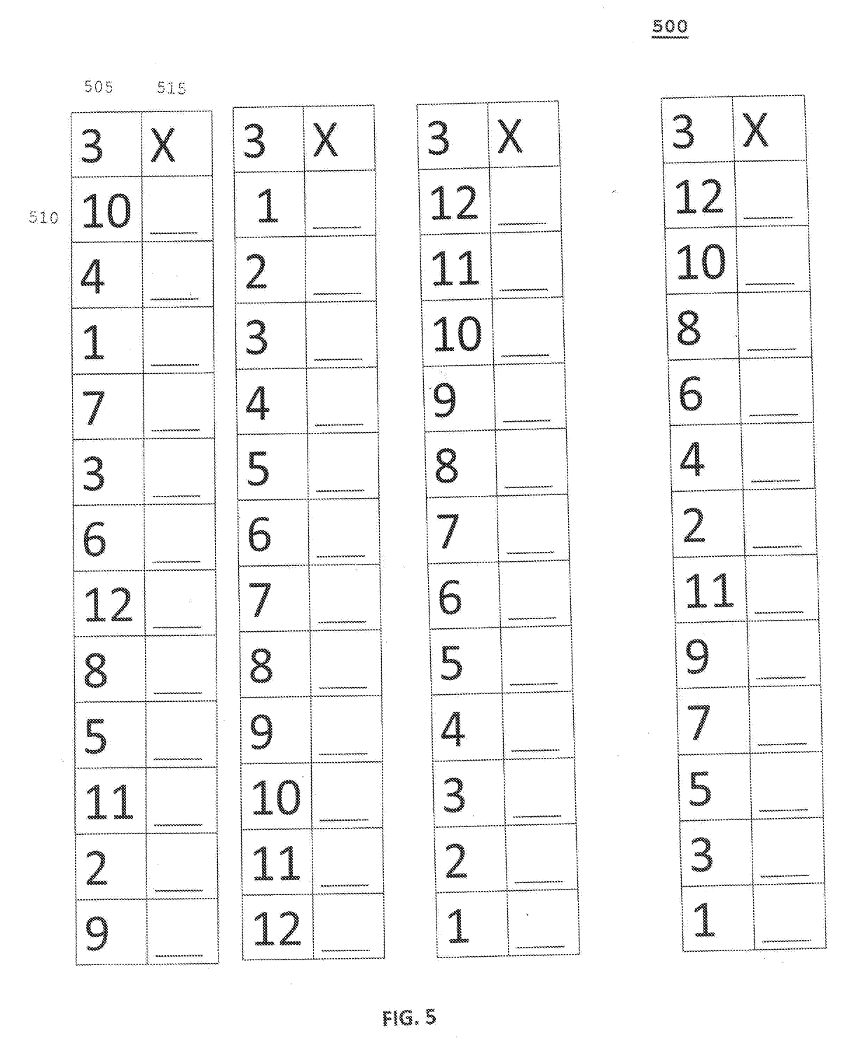

Competitors 115 and 120 of the multiplication table system use the answer interface to answer a question based on the mode of operation of the system. In one embodiment, a shape of the multiplicand as depicted in FIG. 4 and further described below is used as a selectable interface. In other embodiments multiplication strips as shown in FIG. 5 are used.

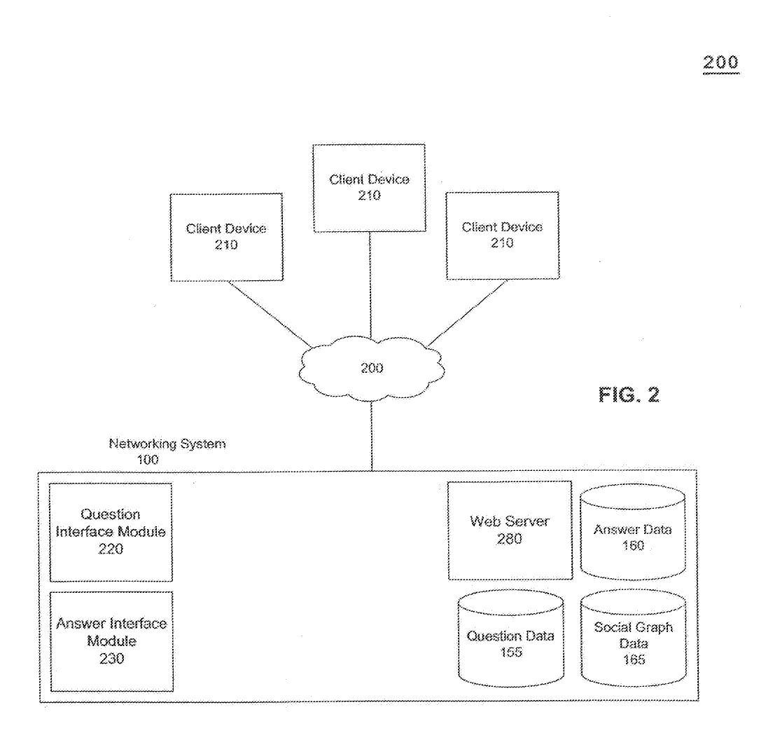

FIG. 2 depicts a high-level block diagram of an implementation according to the system of FIG. 1. The multiplication networking system of FIG. 1 includes a question interface module 220, an answer interface module 230, a teachers' interface module 240, a multiplicand shape module module 250, a web server 280, question data storage module 155, answer data storage module 160, and social data storage module 165. In other embodiments, networking system 100 include additional, fewer, or different modules for various applications. Conventional components such as network interfaces, security functions, load balancers, failover servers, management and network operations consoles, and the like are not shown for better explanation of the details of the system.

Web server 280 links networking system 100 via network 200 to one or more client devices 210; web server 280 serves web pages, as well as other web-related content, such as Java, Flash, XML, and so forth. The web server 280 may provide the functionality of receiving and routing messages between networking system 100 and client devices 210, for example, instant messages, queued messages (e.g., email), text and SMS (short message service) messages, or messages sent using any other suitable messaging technique. The user can send a request to web server 280 to upload information, for example, images or videos that are embedded in a question to question data stor-age module 155. Additionally, web server 280 may pro-vide API functionality to send data directly to native client device operating systems, such as iOS, DROID, webOS, and RIM.

Web server 280 may also serve web pages including question interfaces and answer interfaces via the network 200 to client devices 210. Alternatively, the web server 280 may also render question interfaces and answer interfaces in native applications on client devices 210. In one embodiment, a web server 280 may render question interfaces on a native plat-form's operating system, such as iOS or ANDRIOD, to appear as embedded advertisements in native applications.

As discussed above, question data storage module 155 and answer data storage module 160 store data related to question and answers, respectively. This includes but is not limited to the contents of questions and answers, the identities of questioning users 105 and answering users 115 and 120. Teachers' interface module 240 works in conjunction with teacher's interface 170 in the teacher assisted mode as described above. Multiplicand shape module 250 is used in the learning session mode.

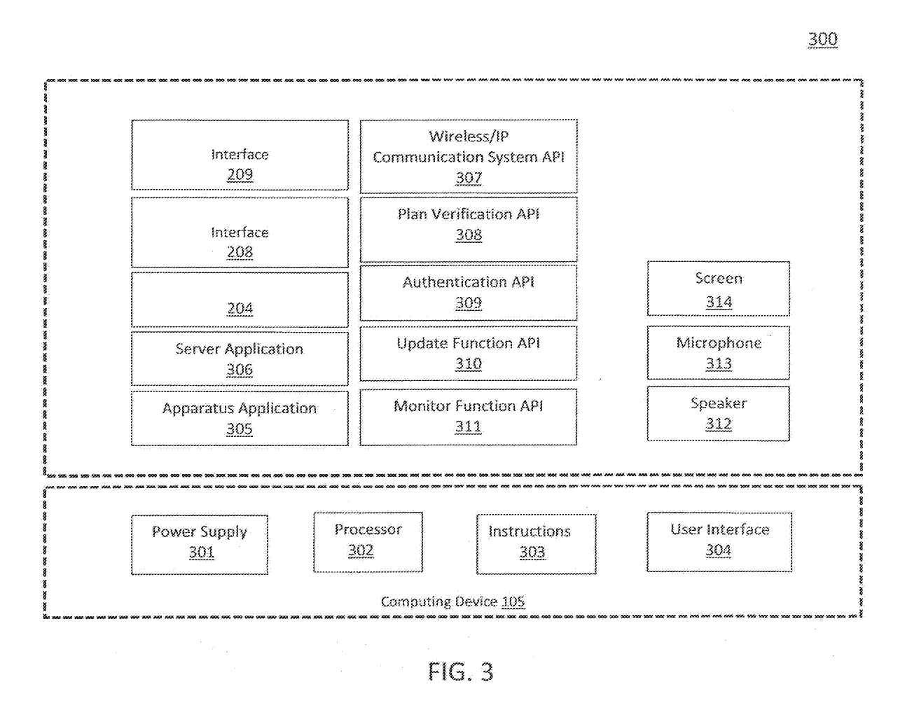

FIG. 3 depicts an exemplary computing device suitable for use in the system depicted in FIG. 1. Computing device 105 may include power supplies 301, a processor 302, and a memory 303 for storing instructions and the like, a user interface 304. Power supply 301 provides power to computing device 105. As such, the power supply may include, for example backup batteries. Other power supply configurations are possible as well. Processor 302 included in computing devices 105 may comprise one or more general-purpose processors and/or one or more special-purpose processors (e.g., image processor, digital signal processor, vector processor, etc.). To the extent that computing device 105 includes more than one processor, such processors could work separately or in combination. Computing device 105 may be configured to control functions of system 100 based on input received from one or more clients via user interface 304, for example.

Memory 303 may comprise one or more volatile and/or nonvolatile storage components such as optical, magnetic, and/or organic storage and memory 303 may be integrated in whole or in part with computing device 105. Memory 303 may contain instructions (e.g., applications programming interface, configuration data) executed by processor 302 in performing various functions of system 100, including any of the functions or methods described herein. Memory 303 may further include instructions executable by processor 302 to control and/or communicate with the additional components.

Peripherals may include speaker 314, microphone 315 and screen 316. Speaker 314 may be configured to output audio to the user of system 100. Similarly microphone 315 may be configured to receive audio from a user of system 100. Screen 316 may comprise one or more devices used for displaying information to the user of computing device 105. Screen 316 may comprise a touchscreen used by a user to input commands to computing device 105. As such, a touchscreen may be configured to sense at least one of a position in the movement of a user's finger via capacitive sensing, or a surface acoustic wave process among other possibilities. Generally, a touchscreen may be capable of Sensing finger movement in a direction parallel or perpendicular to the touchscreen surface of both, and may also be capable of sensing a level of pressure applied to the touchscreen surface. A touchscreen comes in different shapes and forms.

Computing device 105 may include one or more elements in addition to or instead of those shown.

System 100 is developed mainly on two platforms namely, apparatus application 305 and server application 306. Apparatus application 305 is developed using JAVA and Eclipse as SDK (Software Development Kit). Server application 306 is developed using PHP language and MySQL as data base. Languages equivalent to JAVA and Eclipse, PHP and MySQL may be used to build Apparatus application 215 and Server application 3066. Various APIs(308, 309, 310, 311, 312, 313) are used for the various functions (described in greater details infra) of system 100. For Example, (Representational State Transfer) REST API 308, Wireless/IP Communication System API 317 (HTTP) is mainly Used for web services. REST APIs are also used to connect Database on the server with Apparatus application 305. These APIs are also used in various embodiments for transferring data from Server application 306 to Apparatus application 305. Although depicted and described with respect to the aforementioned APIs, it will be appreciated by those skilled in the art that other APIs having similar functionality are considered to be within the scope of the present embodiments.

In one embodiment, APIs (308, 309, 310, 311, 312, 313) are used for passing Email and password parameters from Apparatus application 305 to Server application 306 and used to validate the login of the agent or worker.

In one embodiment, APIs(308, 309, 310, 311, 312,313) transfer Email parameters from Apparatus application 305 to Server application 306 and new password is sent to users email.

Generally speaking, apparatus 105 include any Internet enabled device such as personal digital assistant (PDA), laptop, desktop, electronic book, tablets and the like capable of accessing the Internet may implement the various embodiments described herein. While apparatus 105-108 are generally discussed within the context of the description, the use of any device having similar functionality is considered to be within the scope of the present embodiments.

Although depicted and described with respect to an embodiment in which each of the APIs, engines, databases, and tools is stored within memory 303, it will be appreciated by those skilled in the art that the APIs, engines, database, and/or tools may be stored in one or more other storage devices internal to computing device 105.

The APIs, engines and tools may be activated in any suitable manner. In one embodiment, for example, the APIs, engines and tools may be activated in response to manual requests initiated by a user, in response to automated requests initiated by computing device 105, or other devices and the like, as well as various combinations thereof. For example, where an engine or tool is activated automatically, the engine or tool may be activated in response to scheduled requests, in response to requests initiated by computing device 105 based on processing performed at computing device 105 or apparatus 105-108.

FIG. 4 depicts one embodiment of a shape incorporating therein the factors associated with a Multiplicand. In one embodiment, shape 400 comprises multiplicand numeral 410 and factors 405 placed within the shape. For example, the multiplicand numeral may any number from 0 to 9 for a specific level of education or grade. The higher the grade the multiplicand increases accordingly. Shape 400 is used in conjunction with the multiplication sign 415, which is placed in any suitable position to thereby reflect the operation of multiplication. In some embodiment, the shape incorporates in interactive interface for the user to choose the user.

FIG. 5 depicts one embodiment of a Multiplication Strip associated a Multiplicand. Various multiplication strips are used to facilitate the learning process. In one embodiment, multiplicand 505 is shown and the table is referred to as the “3” multiplication strip, multiplier 510 appears randomly and the learner is expected to identify product 515. Generally, multiplicand 505 identifies the multiplication strip such as the “9” multiplication strip for “9” multiplicand and so on. In other embodiments, the product appears randomly and the learner is expected to identify the multiplier. In other embodiments, multiplier and product are interchanged. In some embodiment, the shape incorporates an interactive interface for the user to choose the answer.

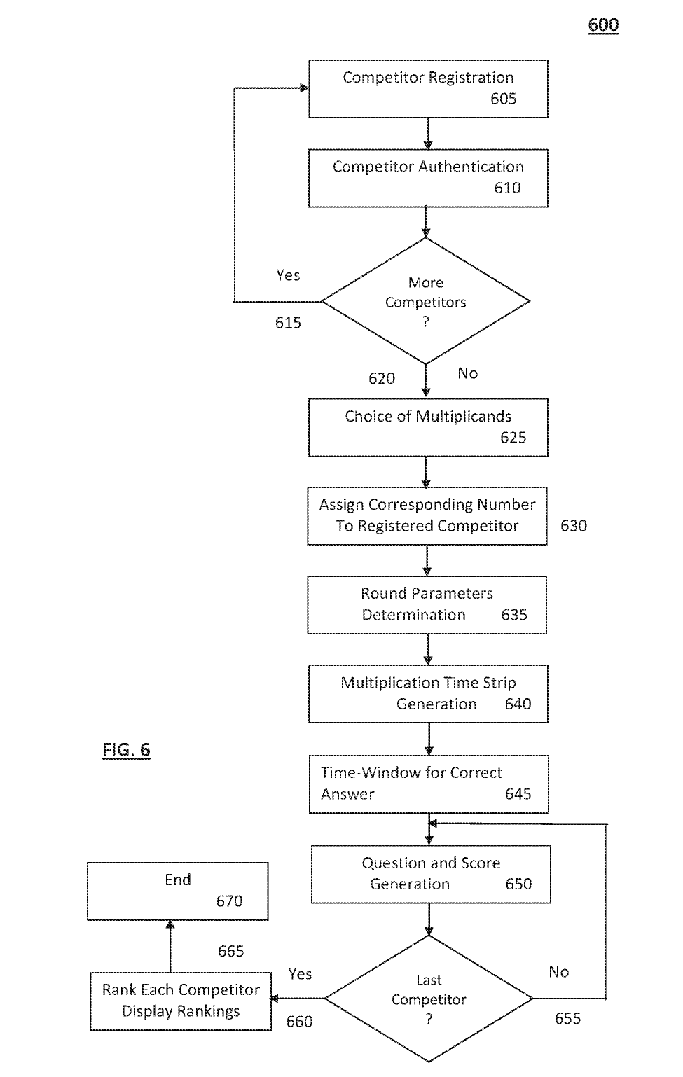

FIG. 6 depicts a Flow Chart of a process for implementing the algorithm according to an embodiment of the invention.

Various embodiments operate to provide a flexible tool that can be tuned to achieve some of the above outlined objectives without sacrificing others. For example, the multiplication strips are used in various combinations as reinforcement, supplement and to test the learner's knowledge because no matter the order of the factors, the multiplicands or multipliers the learner is expected to master the information. Traditional methods rely on memorizing by repetitive recitation. Acknowledging that sight recognition is a superior tool, the present embodiments use the multiplication shape as shown and described above.

At step 605, the competitor registers into the system. In one embodiment, any user may register in the user including teachers, parents, significant others, friends and the like.

At step 610, the competitor or user is authenticated using traditional means for authentication.

At step 605, if there are more users to be registered the system executes step 605. Otherwise, step 620 is executed.

At step 625, the first registered competitor is asked to choose the multiplicand for the session. In other embodiments, the user is asked to choose the mode of operation. In beginner's mode and the multiplication table arrangement is a puzzle, the multiplier or product is associated with a baby animal. For example, the numeral “1” is a kitten, the numeral “2” is a puppy, the numeral “3” is a chick, the numeral “4” is a rabbit, the numeral “5” is a bear cub, the numeral “6” is a frog, the numeral “7” is a lady bug, the numeral “8” is a spider, the numeral “9” is a bumble bee, the numeral “10” is a lion cub, the numeral “11” is a tiger cub, the numeral “12” is a baby elephant. In other embodiments, the baby animal association with a numeral is reversed. For example, the numeral “1” is a baby elephant, the numeral “2” is a tiger cub and so on.

In other embodiments, the multiplier or product is associated with fruit, vegetables or shapes. For example, the numeral “1” is a banana or ear of corn, the numeral “2” is a pumpkin or orange, the numeral “3” is a pear or cabbage, the numeral “4” is an apple or circle, the numeral “5” is a kiwi or eggplant, the numeral “6” is grapes or triangle, the numeral “7” is a square or rectangle, the numeral “8” is an octagon or grapes, the numeral “9” is a cucumber or watermelon, the numeral “10” is a cantaloupe or sweet potato, the numeral “11” is lima bean or star, the numeral “12” is a dominoes or heart. In other embodiments, the fruit, vegetable or shapes association with a numeral is reversed. For example, the numeral “1” dominoes or heart, the numeral “2” is a lima bean or star and so on.

At step 630, a number is assigned to the competitor based on a “first come, first serve” basis, thus establishing the order for who goes first.

At step 635, the parameters for the session are determined. These parameters include starting point, length of the session, retries, point assignment, time window for correct answer and the like.

At step 640, the multiplication time strip is generated based on the mode of operation and the user's particular choice of interface, which may be a rectangle, a square, a heart or any other suitable design. Furthermore, in teacher's assisted mode, the teacher instructs students to begin the multiplication challenge (If the teacher is instructing one-on-one, she or he should say to the student, “What do you see—pointing to the factor, then “What do you say!” pointing to the product.)

At step 645, the timer is loaded with the time window determined in step 635 and the first session or round is ready to begin.

At step 650, the question is displayed to the corresponding user as described above. A score is generated and is associated with the particular user.

At step 665, if there are more users or competitors the system executes step 650. Otherwise, step 660 is executed.

At step 660, each competitor is ranked and the result is displayed.

At step 670, the session ends.

Although primarily depicted and described herein with respect to the embodiments described herein, it will be appreciated that the algorithm may be used in other embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are pos-sible in light of the above disclosure.

Some portions of this description describe the embodi-ments of the invention in terms of algorithms and symbolic representations of operations on information. These algorith-mic descriptions and representations are commonly used by those skilled in the data processing arts to convey the sub-stance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is imple-mented with a computer program product comprising a com-puter-readable medium containing computer program code, which can be executed by a computer processor for performing any or all of the steps, operations, or processes described.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore 65 intended that the scope of the invention be limited not by this detailed description, but rather by any claims that issue on an application based hereon.

Although various embodiments which incorporate the teachings of the present invention have been shown and described in detail herein, those skilled in the art can readily devise many other varied embodiments that still incorporate these teachings.

We claim:

1. A computer-implemented method, comprising:
accessing a networking system multiplication table associated with a plurality of multiplicands to register as a competitor of said networking system multiplication table, the multiplication table associated with a plurality of multipliers and a plurality of products in a predetermined order;
presenting said plurality of multiplicands to the registered competitor;
selecting one of the plurality of multiplicands;
associating a number to registered competitors sequentially;
determining the session parameters;
generating, by a processor, a multiplication time strip corresponding to the selected multiplicand;
establishing a time-window for competitors to provide the correct answer;
presenting a question associated with the selected multiplicand to the competitor with highest priority; and
sending for display to the viewing user earned points based on the answer provided.

2. The computer-implemented method of claim 1, wherein the plurality of multipliers is associated with a specific multiplicand for a particular session.

3. The computer-implemented method of claim 1, wherein the session parameters include one or more of starting point, length of session, mode of operation.

4. The computer-implemented method of claim 3, wherein the starting point is determined based on one or more of timing, predetermined number of competitors.

5. The computer-implemented method of claim 3, wherein the length is determined based on the time taken to answer all the questions.

6. The computer-implemented method of claim 1, wherein a first registered competitor is assigned the highest number and the next competitors are assigned a number corresponding to the order said competitor is registered with respect to the other competitors.

7. The computer-implemented method of claim 1, further comprising:
providing a selectable interface within the multiplication time strip display configured to allow the competitor to choose an answer.

8. The computer-implemented method of claim 6, wherein the answer is associated with one of the product, the multiplier, the multiplicand.

9. The computer-implemented method of claim 1, wherein the registered competitors comprise all networking users from one or more of a particular school grade, age category.

10. The computer-implemented method of claim 1, wherein an arrangement of the multiplication table is configured as a puzzle.

11. The computer-implemented method of claim 1, wherein an arrangement of the multiplication table is configured as a board game.

12. The computer-implemented method of claim 1, wherein an arrangement of the multiplication table is configured as a multiplicand shape.

13. The computer-implemented method of claim 11, further comprising:
providing a selectable interface within the multiplicand shape configured to incorporate the plurality of products associated with the multiplier.

14. A system comprising:
a non-transitory computer-readable storage medium comprising executable computer instructions configured to, when executed, perform the steps comprising:
accessing a networking system multiplication table associated with a plurality of multiplicands to register as a competitor of said networking system multiplication table, the multiplication table associated with a plurality of multipliers and a plurality of products in a predetermined order;
presenting said plurality of multiplicands to the registered competitor;
selecting one of the plurality of multiplicands;
associating a number to registered competitors sequentially;
determining the starting point and length of a particular round;
generating, a multiplication time strip corresponding to the selected multiplicand;
establishing a time-window for competitors to provide the correct answer;
presenting a question associated with the selected multiplicand to the competitor with highest priority; and
sending for display to the viewing user earned points based on the answer provided; and
a processor configured to execute the computer instructions.

15. The system of claim 14 comprising:
presenting a plurality of multiplicands to a registered competitor;
selecting one of the plurality of multiplicands;
associating a number to registered competitors sequentially;
determining the starting point and length of a particular round;
generating, by a processor, a multiplication time strip corresponding to the selected multiplicand;
establishing a time-window for competitors to provide the correct answer;
presenting a question associated with the selected multiplicand to the competitor with highest priority; and
sending for display to the viewing user earned points based on the answer provided,
wherein multiplication table associated with a plurality of multiplicands to register as a competitor of said networking system multiplication table, the multiplication table associated with a plurality of multipliers and a plurality of products in a predetermined order.

16. The system of claim 14, further comprising:
means for implementing the multiplication table as a board game; and
means for implementing the multiplication as a puzzle.
